(19) United States
(12) Patent Application Publication
(10) Pub. No.: US 2005/0265143 A1
(43) Pub. Date: Dec. 1, 2005

(54) Optical head device

(76) Inventors: Hiroshi Kubota, Nagano (JP); Hiroshi Sakai, Nagano (JP); Manabu Sakamoto, Nagano (JP)

Correspondence Address: CANTOR COLBURN, LLP, 55 GRIFFIN ROAD SOUTH, BLOOMFIELD, CT, 06002, US

(21) Appl. No.: 11/136,936

(22) Filed: May 25, 2005

(30) Foreign Application Priority Data
May 27, 2004 (JP) 2004-157001

(51) Int. Cl. G11B 7/00; G11B 7/135

(52) U.S. Cl. 369/44.23; 369/112.01; 369/112.27; 369/112.23

(57) ABSTRACT

An optical head device may include an objective lens drive device for driving an objective lens, an optical path defining optical system which defines an optical path directing to the objective lens from the light source and an optical path directing to a light receiving element from the objective lens, a device frame which holds the objective lens drive device on an upper face side of the device frame and on which the optical path defining optical system is mounted, an aberration compensating element which is mounted on the upper face of the device frame and disposed between the optical path defining optical system and the objective lens for compensating aberration of the laser beam that is converged on the optical recording disk, and a wavelength plate which is disposed between the optical path defining optical system and the objective lens for converting a polarization direction of the laser beam emitted from the optical path defining optical system.

### CROSS REFERENCE TO RELATED APPLICATION

The present invention claims priority under 35 U.S.C. §119 to Japanese Application No. 2004-157001 filed May 27, 2004, which is incorporated herein by reference.

### FIELD OF THE INVENTION

The present invention relates to an optical head device that is used for recording and reproduction of information on and from an optical recording disk such as a CD or a DVD (Digital Versatile Disk). More specifically, the present invention relates to the mounting structure of an aberration compensating element for compensating for aberrations that are generated in an optical system used for the optical head device.

### BACKGROUND OF THE INVENTION

An optical head device used for recording and reproduction for an optical recording disk commonly includes an objective lens drive device for driving an objective lens at least in a tracking direction and in a focusing direction for converging an emitted light beam from a light source on the optical recording disk and a device frame which holds the objective lens drive device on its upper face side and on which an optical path defining optical system is mounted that defines an optical path ranging from the light source to the objective lens and an optical path ranging from the objective lens to a light receiving element.

When recording and reproduction is performed on and from an optical recording disk with a high recording density such as a DVD, a small optical spot is required to be formed on the recording face of the optical recording disk. In this case, the occurrence of aberration cannot be avoided due to an optical element itself, the variation in the thickness of the optical recording disk, or the structure of the recording layer formed in multi-layers. Therefore, optical head devices provided with an aberration compensating element have been proposed (see, for example, Japanese Patent Laid-Open No. 2003-141771, Japanese Patent Laid-Open No. 2003-323736 item official bulletin, and Japanese Patent Laid-Open No. 2004-118931).

In the optical head device described in Japanese Patent Laid-Open No. 2003-141771, a wavelength plate is disposed between a polarizing beam splitter and an objective lens and an aberration compensating element is disposed between a beam shaping prism and the polarizing beam splitter. In the optical head device described in Japanese Patent Laid-Open No. 2003-323736, an aberration compensating element and a wavelength plate are disposed between a polarizing beam splitter and an objective lens. In the optical head device described in Japanese Patent Laid-Open No. 2004-118931, an aberration compensating element is mounted on the slide base for an objective lens drive device.

In the optical head device described in Japanese Patent Laid-Open No. 2003-323736 or Japanese Patent Laid-Open No. 2004-118931, an aberration compensating element is disposed between the optical path defining optical system and the objective lens. Therefore, the laser beam in which the entire aberration of the optical path defining optical system is compensated by the aberration compensating element is guided to the objective lens.

However, in an optical head device, the inclination angle of an objective lens is adjusted by means of that the inclination of an objective lens drive device is adjusted with respect to a device frame when the objective lens drive device is mounted on the device frame. Therefore, in the case that an aberration compensating element is mounted on the slide base for the objective lens drive device as described in Japanese Patent Laid-Open No. 2004-118931, the aberration compensating element is also inclined when the tilt of the objective lens drive device is adjusted. As a result, the center of the aberration compensating element and the optical axis of the optical path defining optical system are displaced each other and thus the aberration becomes larger.

In addition, in order to dispose the aberration compensating element between the optical path defining optical system and the objective lens, the aberration compensating element is required to be disposed between the device frame and the objective lens drive device. However, a wavelength plate is also disposed there and thus the thickness of the optical head device increases.

### SUMMARY OF THE INVENTION

In view of the problems described above, the present invention may advantageously provide an optical head device in which, even when an aberration compensating element is disposed between an optical path defining optical system and an objective lens and the inclination adjustment for the objective lens is performed, the positional relationship between the aberration compensating element and the optical path defining optical system does not displace.

Thus, according to an embodiment of the present invention, there may be provided an optical head device including an objective lens for converging a laser beam emitted from a light source on an optical recording disk, an objective lens drive device for driving the objective lens at least in a tracking direction and a focusing direction, an optical path defining optical system which defines an optical path directing to the objective lens from the light source and an optical path directing to a light receiving element from the objective lens, a device frame which holds the objective lens drive device on the upper face side of the device frame and on which the optical path defining optical system is mounted, an aberration compensating element which is mounted on an upper face side of the device frame and disposed between the optical path defining optical system and the objective lens for compensating aberration of the laser beam that is converged on the optical recording disk, and a wavelength plate which is disposed between the optical path defining optical system and the objective lens for converting the polarization direction of the laser beam emitted from the optical path defining optical system.

According to the optical head device of the present invention, since the aberration compensating element is disposed between the optical path defining optical system and the objective lens, the aberration of the entire optical path defining optical system is compensated by the aberration compensating element and then the compensated laser beam can be guided to the objective lens. Further, since the aberration compensating element is mounted on the device frame side, the aberration compensating element does not incline even when the inclination of the objective lens is adjusted by adjusting the inclination of the objective lens drive device with respect to the device frame in the case that the objective lens drive device is mounted on the device frame. Therefore, the center of the aberration compensating element can be maintained to be coincident with the optical axis of the optical path defining optical system and thus the aberration due to the positional deviation between the aberration compensating element and the optical axis of the optical path defining optical system does not occur.

In accordance with an embodiment of the present invention, the aberration compensating element is preferably mounted on a recessed part which is formed on the upper face of the device frame. According to the construction described above, even though a space between the device frame and the objective lens drive device is very narrow, both the aberration compensating element and the wavelength plate can be disposed between the device frame and the objective lens drive device. Therefore, even when the aberration compensating element is disposed between the optical path defining optical system and the objective lens, the thickness of the optical head device may not be increased. In this case, a transmission type of liquid crystal panel may be used as the aberration compensating element.

In accordance with an embodiment of the present invention, the wavelength plate is mounted, for example, on the under face side with respect to the objective lens drive device. In this case, the wavelength plate is preferably mounted on a recessed part which is formed on the under face of the objective lens drive device. According to the construction described above, even though a space between the device frame and the objective lens drive device is very narrow, both the aberration compensating element and the wavelength plate can be disposed between the device frame and the objective lens drive device and thus the thickness of the optical head device may not be increased.

In accordance with an embodiment of the present invention, the wavelength plate is mounted on the aberration compensating element that is mounted on the upper face of the device frame.

In accordance with an embodiment of the present invention, the aberration compensating element is preferably mounted in an inclined state with respect to the optical axis of the laser beam emitted from the optical path defining optical system. According to the construction described above, even when the laser beam emitted from the optical path defining optical system is reflected by the aberration compensating element, the reflected laser beam does not reach the light source or the light receiving element as a stray light.

In accordance with an embodiment of the present invention, the objective lens drive device is constructed so that an angle of inclination of the objective lens drive device can be adjusted with respect to the optical axis of the laser beam emitted from the optical path defining optical system and the wavelength plate is mounted in an inclined state with respect to the optical axis of the laser beam emitted from the optical path defining optical system even when the objective lens drive device is adjusted at any angle within the range of inclination adjustment of the objective lens drive device. According to the construction described above, even when the laser beam emitted from the optical path defining optical system is reflected by the wavelength plate, the reflected laser beam does not reach the light source or the light receiving element as a stray light.

In accordance with an embodiment of the present invention, a first light source and a second light source for emitting laser beams with different wavelengths to each other are provided as the light source, and the optical path defining optical system includes an optical path composing element for composing an optical path of the laser beam emitted from the first light source and an optical path of the laser beam emitted from the second light source. The aberration compensating element is disposed on an optical path ranging from the optical path composing element to the objective lens. Therefore, the aberration of emitted light beams from the first light source and the second light source can be compensated by a common aberration compensating element.

According to the optical head device of the present invention, since the aberration compensating element is disposed between the optical path defining optical system and the objective lens, the aberration of the entire optical path defining optical system is compensated by the aberration compensating element and then the compensated laser beam can be guided to the objective lens. Also, since the aberration compensating element is mounted on the device frame side, the aberration compensating element does not incline even when the inclination of the objective lens is adjusted by adjusting the inclination of the objective lens drive device with respect to the device frame in the case that the objective lens drive device is mounted on the device frame. Therefore, the center of the aberration compensating element can be maintained to be coincident with the optical axis of the optical path defining optical system. Accordingly, the aberration due to the positional deviation between the aberration compensating element and the optical axis of the optical path defining optical system does not occur and thus a high density recording for an optical recording disk can be performed.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1(a) is a perspective view showing an optical head device, which is viewed from obliquely above, in accordance with an embodiment of the present invention, and FIG. 1(b) is a perspective view showing the optical head device which is viewed from obliquely below.

FIG. 2(a) is an explanatory view schematically showing the layout of an optical system where the optical head device shown in FIG. 1(a) is viewed from a side face side, and FIG. 2(b) is an explanatory view schematically showing the layout of the optical system where the optical head device is viewed from a bottom face side.

FIG. 3 is an enlarged cross-sectional view showing a portion on which an aberration compensating element is mounted in the optical head device shown in FIG. 1(a).

FIG. 4 is a perspective view showing the upper face side of the device frame viewed from obliquely above in which the objective lens drive device is detached in the optical head device shown in FIG. 1(a).

FIG. 5 is a perspective view showing the under face side of the objective lens drive device viewed from obliquely below, which is detached from the device frame in the optical head device shown in FIG. 1(a).

FIG. 6 is an explanatory view schematically showing the layout of an optical system viewed from a side face side of an optical head device in accordance with another embodiment of the present invention.

### DETAILED DESCRIPTION OF THE PREFERRED EMBODIMENTS

Embodiments of the present invention will be described below with reference to the accompanying drawings.

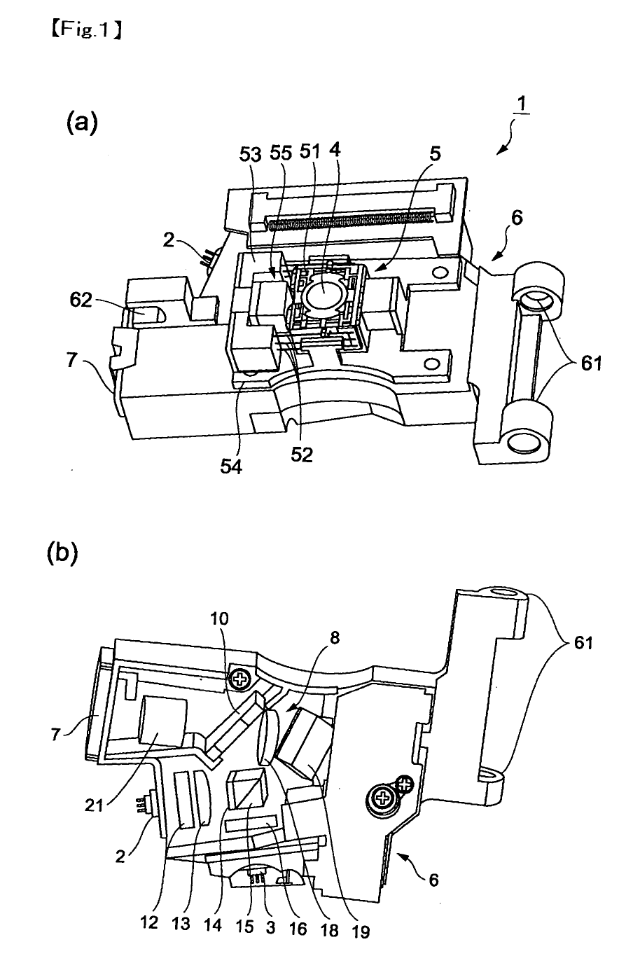

FIG. 1(a) is a perspective view showing an optical head device, which is viewed from obliquely above, in accordance with an embodiment of the present invention, and FIG. 1(b) is a perspective view showing the optical head device which is viewed from obliquely below.

The optical head device 1 shown in FIGS. 1(a) and 1(b) performs recording and reproducing of information on and from an optical recording disk (not shown) such as a CD or a DVD. The optical head device 1 includes a first and a second laser diodes 2 and 3 as a light source, an objective lens 4 for converging emitted light beams from the first and the second laser diodes 2 and 3 on an optical recording disk (not shown), an objective lens drive device 5 for driving the objective lens 4 in the tracking, focusing and tilt directions, and a device frame 6 which holds the objective lens drive device 5 on its upper face side and on which the first and the second laser diodes 2 and 3, an optical path defining optical system 8 described later and the like are mounted. The first laser diode 2 is a laser diode for a DVD which emits a first laser beam with a wavelength of 650 nm or 635 nm (short wavelength). The second laser diode 3 is a laser diode for a CD which emits a second laser beam with a wavelength of 760 to 800 nm (long wavelength).

Guide holes 61 formed of a circular hole and a guide part 62 protruded so as to be formed in a U-shape are formed on both end parts of the device frame 6. The optical head device 1 can be moved in the radial direction of the optical recording disk along guide shafts (not shown) which are passed through the guide holes 61 and the guide part 62.

The objective lens drive device 5 includes a lens holder 51 which holds the objective lens 4, a holder support member 53 which movably supports the lens holder 51 in the tracking, focusing and tilt directions with six wires 52 that are disposed at three positions in the vertical direction on the right and left sides of the lens holder 51, and a yoke 54 for fixing and holding the holder support member 53. The yoke 54 is mounted on the device frame 6. In this state, the objective lens drive device 5 is mounted on the upper face side of the device frame 6.

The objective lens drive device 5 is provided with a magnetic-drive circuit 55 comprising of drive coils fixed to the lens holder 51 and drive magnets fixed to the yoke 54. The objective lens 4 held to the lens holder 51 can be driven with respect to the optical recording disk in the tracking, focusing and tilt directions by controlling energization to the drive coils.

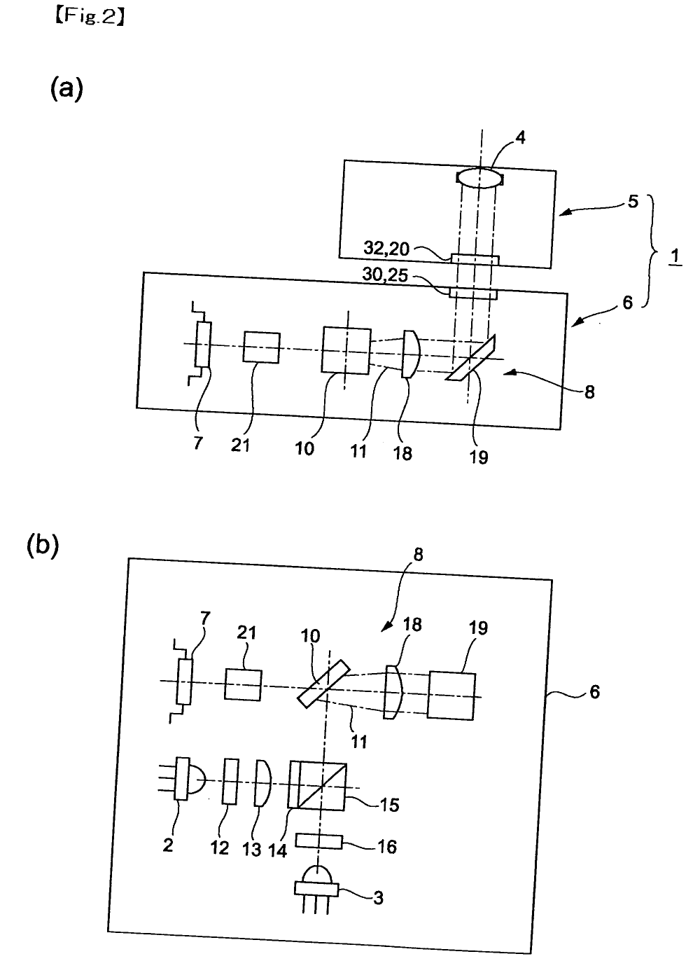

FIG. 2(a) is an explanatory view schematically showing the layout of an optical system where the optical head device shown in FIG. 1(a) is viewed from a side face side, and FIG. 2(b) is an explanatory view schematically showing the layout of the optical system where the optical head device is viewed from a bottom face side.

As shown in FIG. 1(b) and FIGS. 2(a) and 2(b), in the optical head device 1 in the embodiment of the present invention, on the device frame 6 are mounted a prism 15, a half mirror 10, a collimating lens 18 and a raising mirror 19, which construct an optical path defining optical system 8 for defining an optical path directing to the objective lens 4 from the first and the second laser diodes 2 and 3 and defining an optical path directing to the light receiving element 7 from the objective lens 4. As described in detail later, either of the first laser beam emitted from the first laser diode 2 and the second laser beam emitted from the second laser diode 3 is guided to a common optical path 11 directing to the optical recording disk by using the prism 15 comprising a polarizing beam splitter as an optical path composing element and the half mirror 10 as an optical path separating element and then converged on the recording face of the optical recording disk by the objective lens 4. The return light beam of the laser beam reflected by the optical recording disk is separated from the common optical path 11 by the half mirror 10 and guided to the light receiving element 7.

On the optical path directing to the optical recording disk from the first laser diode 2 on the device frame 6 are disposed a first grating lens 12, the relay lens 13, a ½ wavelength plate 14, the prism 15, the half mirror 10, the collimating lens 18 and the raising mirror 19 in this order. Therefore, the first laser beam emitted from the first laser diode 2 is transmitted through the first grating lens 12, the relay lens 13 and the ½ wavelength plate 14, and reflected by the prism 15. After a part of the first laser beam is partially reflected by the half mirror 10, the first laser beam is formed to be a parallel light by the collimating lens 18 and then guided upward by the raising mirror 19.

On the optical path directing to the optical recording disk from the second laser diode 3 are disposed a second grating lens 16, the prism 15, the half mirror 10, the collimating lens 18 and the raising mirror 19 in this order. Therefore, the second laser beam emitted from the second laser diode 3 is transmitted through the second grating lens 16 and then transmitted through the prism 15. After a part of the second laser beam is partially reflected by the half mirror 10, the second laser beam is formed to be a parallel light by the collimating lens 18 and then guided upward by the raising mirror 19.

An aberration compensating element 25 and a ¼ wavelength plate 20 are disposed in this order between the raising mirror 19 and the objective lens 4 which is disposed on the upper side of the raising mirror 19. Therefore, the aberration of the laser beam which is guided upward by the raising mirror 19 is compensated by the aberration compensating element 25 and then converted into a circular polarized light by the ¼ wavelength plate 20 to converge as an optical spot on the recording face of the optical recording disk by the objective lens 4. In this case, the position of the objective lens 4 is servo-controlled by the objective lens drive device 5 in the tracking direction, the focusing direction and the tilt direction.

The return light beam of the laser beam reflected by the optical recording disk passes the above-mentioned optical path in the reverse direction and guided to the half mirror 10 through the objective lens 4, the ¼ wavelength plate 20, the aberration compensating element 25, the raising mirror 19, and the collimating lens 18. The light beam transmitted through the half mirror 10 transmits to the sensor lens 21 and reaches the light receiving element 7. The sensor lens 21 is a lens for generating an astigmatism with respect to both the return light beams of the laser beams.

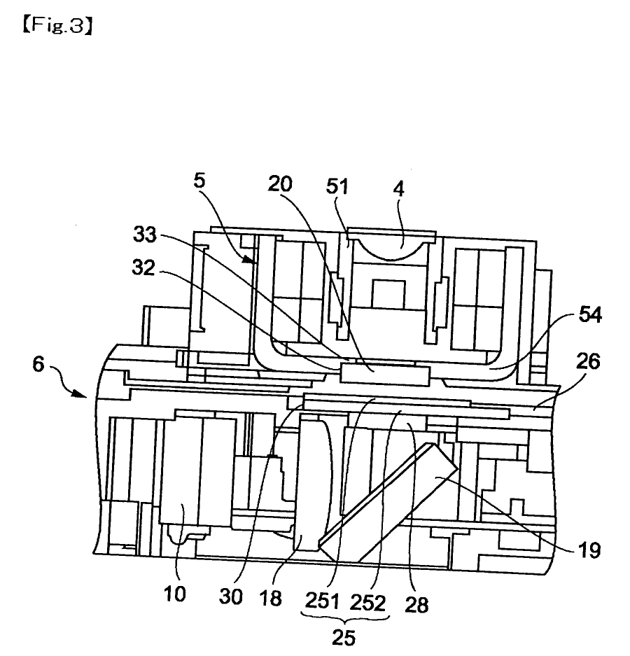

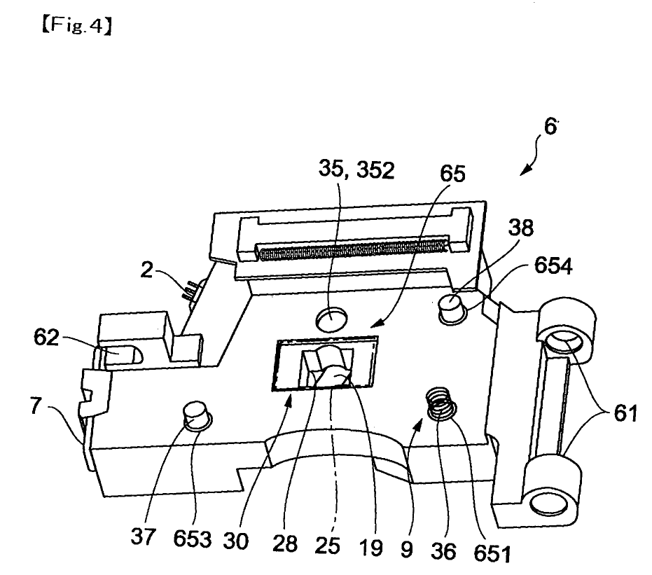

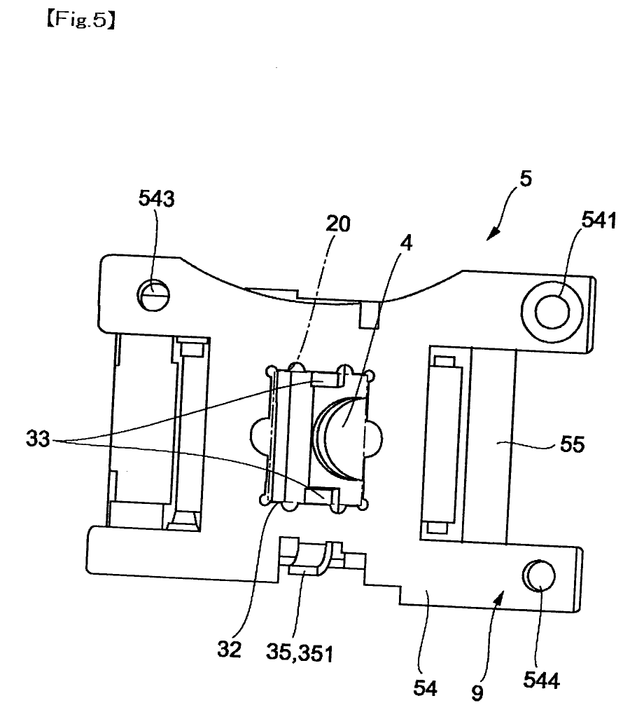

FIG. 3 is an enlarged cross-sectional view showing a portion on which an aberration compensating element 25 is mounted on the optical head device 1 shown in FIG. 1(a). FIG. 4 is a perspective view showing the upper face side of the device frame 6 viewed from obliquely above in which the objective lens drive device 5 is detached in the optical head device 1 shown in FIG. 1(a). FIG. 5 is a perspective view showing the under face side of the objective lens drive device 5 viewed from obliquely below, which is detached from the device frame 6 in the optical head device 1 shown in FIG. 1(a).

As shown in FIG. 3, in the embodiment of the present invention, a liquid crystal panel (LCD) is used for the aberration compensating element 25. A well-known transmission type of liquid crystal panel can be utilized and thus its detailed description is omitted. However, this device is not limited to LCD's and many forms of “adaptive optics” or “active” optics may also be used. However, a transparent electrode for driving a liquid crystal is formed on each of a pair of substrates 251 and 252. The liquid crystal is held between the pair of substrates 251 and 252. A number of terminals are formed on the protruding region of the substrate 252 so as to be formed along one side of the substrate and a flexible circuit board 26 is connected to the terminals. Therefore, in the aberration compensating element 25, the alignment state of the liquid crystal can be controlled in each area by a signal inputted from the flexible circuit board. Therefore, when the laser beam emitted from the laser diode 2 or 3 is incident on the aberration compensating element 25 through the above-mentioned optical path defining optical system 8, the laser beam is phase-modulated by the aberration compensating element 25 and emitted to the ¼ wavelength plate 20. Accordingly, even though the occurrence of aberration cannot be avoided due to the optical elements themselves, the uneven thickness of an optical recording disk or the recording layer formed to be multilayered, the laser beam is emitted to the ¼ wavelength plate 20 in the state that the aberration is corrected and thus an optical spot can be satisfactorily formed on the recording face of the optical recording disk and the recording or reproduction of information on or from the optical recording disk can be performed with a high degree of accuracy. In the embodiment of the present invention, the aberration compensating element 25 is not limited to a liquid crystal panel and may utilize an element which can compensate the aberration of the laser beam by controlling or the like from the outside.

In an embodiment of the present invention, the aberration compensating element 25 and the ¼ wavelength plate 20 are mounted on the optical head device 1, as schematically shown in FIG. 2(a), such that the ¼ wavelength plate 20 is mounted on the objective lens drive device 5 and the aberration compensating element 25 is mounted on the device frame 6. The mounting structure of the aberration compensating element 25 and the ¼ wavelength plate 20 will be described in detail below.

As shown in FIG. 2(a), FIG. 3 and FIG. 4, an aperture part 28 for securing an optical path directing to the objective lens 4 from the raising mirror 19 is formed to be penetrated in the device frame 6. A recessed part 30 is formed at the edge part of the aperture part 28 on the upper face side so as to be lower than a mounting face 65 on which the objective lens drive device 5 is mounted. The recessed part 30 is formed in a shape corresponding to the aberration compensating element 25 so as to be capable of fitting the aberration compensating element 25 to the recessed part 30. The position of the aberration compensating element 25 is adjusted such that the optical axis of the laser beam reflected by the raising mirror 19 is coincident with the center position of the aberration compensating element 25 and then the aberration compensating element 25 is adhesively fixed on the recessed part 30. Further, the aberration compensating element 25 is fixed so as to be inclined in the state in which the angle of inclination is set to be about 1 to 2 degrees with respect to the optical axis of the laser beam reflected by the raising mirror 19. Therefore, even when the laser beam reflected by the raising mirror 19 is reflected by the aberration compensating element 25, it does not reach the light receiving element 7 or the laser diodes 2 and 3 as a stray light.

Further, as shown in FIG. 2(a), FIG. 3 and FIG. 5, the ¼ wavelength plate 20 is adhesively fixed on the under face side of the objective lens drive device 5. In other words, on the bottom plate portion of a yoke 54 is formed a wavelength plate insert hole 32 (recessed part) for capable of inserting the ¼ wavelength plate 20. A pair of projecting parts 33 is protruded toward an inner side from the edge part of the wavelength plate insert hole 32 on the objective lens 4 side. The ¼ wavelength plate 20 is pressed to the projecting parts 33 to be positioned and the ¼ wavelength plate 20 is fixed to the support pieces (projecting parts 33) with an adhesive.

In the steps for assembling the optical head device 1 having the construction described above, when the objective lens drive device 5 shown in FIG. 5 is mounted on the device frame 6 shown in FIG. 4, the inclination of the objective lens drive device 5 with respect to the device frame 6 is required to be adjusted, in other words, the angle of inclination of the objective lens 4 is required to be adjusted, such that the optical axis of the objective lens 4 is set to be accurately perpendicular to the recording face of the optical recording disk in order to perform recording and reproduction of information on and from the optical recording disk correctly. Therefore, an inclination adjusting mechanism 9 is constructed between the objective lens drive device 5 and the device frame 6 for adjusting the inclination of the objective lens drive device 5 to the device frame 6.

The objective lens inclination adjusting mechanism 9 includes, for example, a supporting part 35 that serves as a supporting point when the objective lens drive device 5 is inclined with respect to the device frame 6, a helical compression spring 36, and two inclination adjusting screws 37 and 38. The supporting part 35 is comprised of a protruded part 351 which is bent downward from the bottom plate portion of the yoke 54 in the objective lens drive device 5 and a recessed part 352 formed on the mounting face 65 of the device frame 6. The helical compression spring 36 is disposed at an opposite side position apart from the supporting part 35 between the device frame 6 and the objective lens drive device 5. Concretely, both ends of the helical compression spring 36 are respectively held by a receiving part 541 formed on the bottom plate portion of the yoke 54 and a receiving part 651 formed on the mounting face 65 of the device frame 6. The two inclination adjusting screws 37 and 38 are disposed at opposite angle positions where the compression coil spring 36 is not disposed among four corner portions of the objective lens drive device 5. The respective screw shafts are passed through screw holes 653, 654 formed in the device frame 6 from the rear face side of the device frame 5 and screwed into screw holes 543, 544 formed in the bottom plate portion of the yoke 54. Therefore, the inclination of the objective lens drive device 5 with respect to the device frame 6 can be adjusted by adjusting the amount of tightening of two inclination adjusting screws 37, 38 and thus the inclination of the objective lens 4 can be adjusted.

The ¼ wavelength plate 20 is fixed on the under face side of the objective lens drive device 5 so as to have an inclination angle which is larger than that of the upper limit in the adjusting range of inclination of the objective lens drive device 5. Therefore, even when the inclination adjustment of the objective lens drive device 5 is performed at any angle, the ¼ wavelength plate 20 is fixed so as to be inclined at a prescribed angle to the optical axis of the laser beam reflected by the raising mirror 19. Accordingly, even though the laser beam reflected by the raising mirror 19 is reflected by the ¼ wavelength plate 20, the reflected laser beam does not reach the light receiving element 7 or the laser diode 2, 3 as a stray light.

As described above, in the optical head device 1 in accordance with the above-mentioned embodiment of the present invention, the aberration compensating element 25 is disposed between the optical path defining optical system 8 and the objective lens 4, and thus the aberration of the entire optical path defining optical system 8 including the raising mirror 19 can be collectively compensated. Further, since the aberration compensating element 25 is mounted on the device frame 6 side, the aberration compensating element 25 does not incline even when the inclination of the objective lens 4 is adjusted by adjusting the inclination of the objective lens drive device 5 with respect to the device frame 6 in the case that the objective lens drive device 5 is mounted on the device frame 6. Consequently, the center of the aberration compensating element 25 can be maintained to be coincident with the optical axis of the optical path defining optical system 8 and thus the aberration due to the positional deviation between the aberration compensating element 25 and the optical axis of the optical path defining optical system 8 does not occur.

In an embodiment of the present invention, the aberration compensating element 25 is mounted on the recessed part 30 which is formed on the upper face of the device frame 6. Further, the ¼ wavelength plate 20 is mounted on the wavelength plate insert hole 32 which is formed on the under face of the objective lens drive device 5. Therefore, even though a space between the upper face of the device frame 6 and the under face of the objective lens drive device 5 is narrow, or even though there is no gap space between the upper face of the device frame 6 and the under face of the objective lens drive device 5, both the aberration compensating element 25 and the ¼ wavelength plate 20 can be disposed between the device frame 6 and the objective lens drive device 5. Accordingly, even when both the aberration compensating element 25 and the ¼ wavelength plate 20 are disposed between the optical path defining optical system 8 and the objective lens 4, it is not necessary to change the thickness dimension (height dimension) of the optical head device 1 and thus the thickness of the optical head device 1 is not required to increase. As a result, the optical head device 1 in the embodiment of the present invention can be sufficiently mounted on a notebook-sized personal computer that is required to reduce its thickness.

Further, the aberration compensating element 25 is fixed so as to be in the inclined state in which the angle of inclination is set to be about 1 to 2 degrees with respect to the optical axis of the laser beam that is emitted from the optical path defining optical system 8. Therefore, even when the laser beam reflected by the raising mirror 19 is reflected by the aberration compensating element 25, the reflected laser beam does not reach the laser diodes 2 and 3 or the light receiving element 7 as a stray light. Also, the ¼ wavelength plate 20 is fixed so as to be inclined at a prescribed angle with respect to the optical axis of the laser beam reflected by the raising mirror 19 even when the inclination adjustment of the objective lens drive device 5 is performed at any angle. Accordingly, even though the laser beam reflected by the raising mirror 19 is reflected by the ¼ wavelength plate 20, the reflected laser beam does not reach the laser diode 2, 3 or the light receiving element 7 as a stray light. Consequently, the laser diodes 2 and 3 do not experience mode hopping and thus their outputs are stable. Also, signals can be securely detected in the light receiving element 7. Therefore, recording or reproduction of information on or from an optical recording disk can be accurately performed.

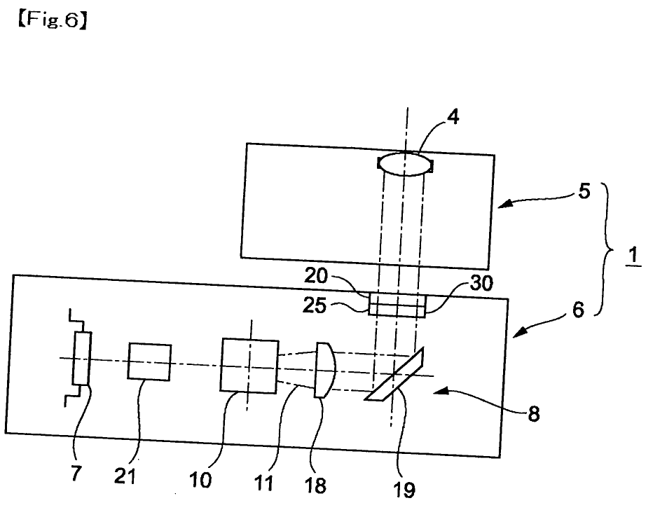

In an embodiment of the present invention, the ¼ wavelength plate 20 is held in the state that it is embedded in the bottom plate portion of the yoke 54 of the objective lens drive device 5. However, as schematically shown in FIG. 6, the aberration compensating element 25 and the ¼ wavelength plate 20 may be integrally mounted in a superposed manner on the recessed part 30 formed in the upper face of the device frame 6.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. An optical head device for use with an optical recording disk comprising:
an objective lens for converging a laser beam emitted from a light source on an optical recording disk;
an objective lens drive device for driving the objective lens at least in a tracking direction and in a focusing direction;
an optical path defining optical system which defines an optical path directed to the objective lens from the light source and an optical path directed to a light receiving element from the objective lens;
a device frame which holds the objective lens drive device on an upper face side of the device frame and on which the optical path defining optical system is mounted;
an aberration compensating element which is mounted on an upper face side of the device frame and disposed between the optical path defining optical system and the objective lens for compensating aberration of the laser beam that is converged on the optical recording disk; and
a wavelength plate which is disposed between the optical path defining optical system and the objective lens for converting a polarization direction of the laser beam emitted from the optical path defining optical system.

2. The optical head device according to claim 1, wherein the aberration compensating element is mounted on a recessed part which is formed on an upper face of the device frame.

3. The optical head device according to claim 2, wherein the aberration compensating element is comprised of a transmission type of liquid crystal panel.

4. The optical head device according to claim 1, wherein the wavelength plate is mounted on an under face side of the objective lens drive device.

5. The optical head device according to claim 4, wherein the wavelength plate is mounted on a recessed part which is formed on an under face of the objective lens drive device.

6. The optical head device according to claim 1, wherein the wavelength plate is mounted on the aberration compensating element in a superposed manner that is mounted on the upper face of the device frame.

7. The optical head device according to claim 1, wherein the aberration compensating element is mounted in an inclined state with respect to an optical axis of the laser beam emitted from the optical path defining optical system.

8. The optical head device according to claim 1, wherein
the objective lens drive device is structured so that an angle of inclination of the objective lens drive device can be adjusted with respect to an optical axis of the laser beam emitted from the optical path defining optical system; and
the wavelength plate is mounted in an inclined state with respect to the optical axis of the laser beam emitted from the optical path defining optical system even when the objective lens drive device is adjusted at any angle within a range of inclination adjustment of the objective lens drive device.

9. The optical head device according to claim 8, wherein the aberration compensating element is mounted on a recessed part which is formed on an upper face of the device frame.

10. The optical head device according to claim 9, wherein the aberration compensating element is mounted in an inclined state with respect to the optical axis emitted from the optical path defining optical system.

11. The optical head device according to claim 10, wherein the wavelength plate is mounted on a recessed part which is formed on an under face of the objective lens drive device.

12. The optical head device according to claim 1, further comprising:
a first light source and a second light source for emitting laser beams with different wavelengths to each other as the light source; and
an optical path composing element included in the optical path defining optical system for composing an optical path of the laser beam emitted from the first light source and an optical path of the laser beam emitted from the second light source;
wherein the aberration compensating element is disposed on an optical path ranging from the optical path composing element to the objective lens.

13. An optical head device for use with an optical recording disk comprising:
an objective lens for converging a laser beam emitted from a light source on an optical recording disk;
an objective lens drive device for driving the objective lens at least in a tracking direction and in a focusing direction;
an optical path defining optical system which defines an optical path directing to the objective lens from the light source and an optical path directing to a light receiving element from the objective lens;
a device frame which holds the objective lens drive device on an upper face side of the device frame and on which the optical path defining optical system is mounted;
an active adaptive optics aberration compensating element which is mounted on an upper face side of the device frame and disposed between the optical path defining optical system and the objective lens for compensating aberration of the laser beam that is converged on the optical recording disk; and
a wavelength plate which is disposed between the optical path defining optical system and the objective lens for converting a polarization direction of the laser beam emitted from the optical path defining optical system.

14. The optical head device according to claim 13, wherein the aberration compensating element is mounted on a recessed part which is formed on an upper face of the device frame.

15. The optical head device according to claim 13, wherein the aberration compensating element is comprised of an actively controllable transmission type of liquid crystal panel.

16. The optical head device according to claim 13, wherein the wavelength plate is mounted on a recessed part which is formed on an under face of the objective lens drive device.

17. The optical head device according to claim 13, wherein the wavelength plate is mounted on the aberration compensating element in a superposed manner that is mounted on the upper face of the device frame.

18. The optical head device according to claim 13, wherein the aberration compensating element is mounted in an inclined state with respect to an optical axis of the laser beam emitted from the optical path defining optical system.

19. The optical head device according to claim 13, wherein the objective lens drive device is constructed structured so that an angle of inclination of the objective lens drive device can be adjusted with respect to an optical axis of the laser beam emitted from the optical path defining optical system; and
the wavelength plate is mounted in an inclined state with respect to the optical axis of the laser beam emitted from the optical path defining optical system even when the objective lens drive device is adjusted at any angle within a range of inclination adjustment of the objective lens drive device.

20. The optical head device according to claim 13, further comprising: p1 a first light source and a second light source for emitting laser beams with different wavelengths to each other as the light source; and
an optical path composing element included in the optical path defining optical system for composing an optical path of the laser beam emitted from the first light source and an optical path of the laser beam emitted from the second light source;
wherein the aberration compensating element is disposed on an optical path ranging from the optical path composing element to the objective lens.
